(19) United States
(12) Patent Application Publication
(10) Pub. No.: US 2007/0059089 A1
(43) Pub. Date: Mar. 15, 2007

(54) Writing instrument

(75) Inventor: Mitch Junkins, Newport Beach, CA (US)

Correspondence Address: BROOKS KUSHMAN P.C., 1000 TOWN CENTER, TWENTY-SECOND FLOOR, SOUTHFIELD, MI, 48075, US

(73) Assignee: Stylus, Inc., Southfield, MI (US)

(21) Appl. No.: 11/505,602

(22) Filed: Aug. 17, 2006

Related U.S. Application Data
(60) Provisional application No. 60/709,374, filed on Aug. 17, 2005.

(51) Int. Cl. B43K 29/00

(52) U.S. Cl. 401/195

(57) ABSTRACT

According to one embodiment of the present invention, a writing instrument is provided. The writing instrument includes a writing tip mechanically coupled to first and second holding parts and separable first and second pieces positionable on the writing instrument, and at least partially retained in a sequence by the first and second holding parts. The first and second pieces include first and second anti-rotation configurations, respectively, that act to prevent their rotation with respect to one another.

### CROSS-REFERENCE TO RELATED APPLICATION

This application claims the benefit of U.S. Provisional Application Ser. No. 60/709,374, filed Aug. 17, 2005.

### BACKGROUND OF THE INVENTION

1. Field of the Invention

One aspect of the present invention is a writing instrument. Another aspect of the present invention is a writing instrument with shaft pieces.

2. Background Art

Writing instruments, such as pens, pencils, and felt tip markers, are commonly used to apply writing, such as text, symbols and drawings, to paper and other suitable surfaces. In addition to their writing functions, in some instances, writing instruments can also operate as toys, objects, d'art, advertisements, and so forth.

It is known to dispose blocks or other objects along the shaft of the writing instrument to provide one or more of the non-writing operations as set forth above. The shaft can include ink or other colorant, or can be a solid piece of metal.

According to one proposal, a number of square blocks having a circular channel are disposed along a shaft having a circular cross-section such that each block is independently rotatable of one another around the shaft. Symbols and/or letters can be imprinted on one or more outer surfaces of each square block. The square blocks can be rotated such that the outer surfaces of the square blocks can be aligned to spell out a message or company name with symbols and/or letters.

In light of the foregoing, what is needed is a writing instrument including separable objects disposed along the shaft that are restricted from rotating relative to one another.

### SUMMARY OF THE INVENTION

According to one embodiment of the present invention, a writing instrument is provided. The writing instrument includes a writing tip mechanically coupled to first and second holding parts and separable first and second pieces positionable on the writing instrument, and at least partially retained in a sequence by the first and second holding parts. The first and second pieces include first and second anti-rotation configurations, respectively, that act to prevent their rotation with respect to one another.

### BRIEF DESCRIPTION OF THE DRAWINGS

The features of the present invention which are believed to be novel are set forth with particularity in the appended claims. The present invention, both as to its organization and manner of operation, together with further objects, features and advantages thereof, may best be understood with reference to the following description, taken in connection with the accompanying drawings:

FIG. 1 is a perspective view of a writing instrument according to one embodiment of the present invention;

FIG. 1a is an exploded perspective view of the writing instrument shown in FIG. 1;

FIG. 1b is an exploded perspective view of the writing instrument shown in FIG. 1 with an alternative shaft according to another embodiment of the present invention;

FIG. 2 is a fragmented, partially exploded, perspective view of a writing instrument according to an embodiment of the present invention;

FIG. 2a is a cross-sectional view of the writing instrument of FIG. 2 taken about line 2a-2a;

FIG. 2b is a cross-sectional view of the writing instrument of FIG. 2 taken about line 2b-2b;

FIG. 2c is a cross-sectional view of the writing instrument of FIG. 2 taken about line 2c-2c;

FIG. 3 is a fragmented, partially exploded, perspective view of a writing instrument according to an embodiment of the present invention;

FIG. 3a is a cross-sectional view of the writing instrument of FIG. 3 taken about line 3a-3a;

FIG. 3b is a cross-sectional view of the writing instrument of FIG. 3 taken about line 3b-3b;

FIG. 4 is a fragmented, partially exploded, perspective view of a writing instrument according to an embodiment of the present invention;

FIG. 4a is a cross-sectional view of the writing instrument of FIG. 4 taken about line 4a-4a;

FIG. 5 is a fragmented, partially exploded, perspective view of a writing instrument according to an embodiment of the present invention;

FIG. 5a is a cross-sectional view of the writing instrument of FIG. 5 taken about line 5a-5a;

FIG. 6 is a fragmented, partially exploded, perspective view of a writing instrument according to an embodiment of the present invention;

FIG. 6a is a cross-sectional view of the writing instrument of FIG. 6 taken about line 6a-6a;

FIG. 7 is a fragmented, partially exploded, perspective view of a writing instrument according to an embodiment of the present invention;

FIG. 7a is a cross-sectional view of the writing instrument of FIG. 7 taken about line 7a-7a;

FIG. 8 is a fragmented, partially exploded, perspective view of a writing instrument according to an embodiment of the present invention;

FIG. 8a is a cross-sectional view of the writing instrument of FIG. 8 taken about line 8a-8a;

FIG. 9 is a fragmented, partially exploded, perspective view of a writing instrument according to an embodiment of the present invention; and

FIG. 9a is a cross-sectional view of the writing instrument of FIG. 9 taken about line 9a-9a.

### DETAILED DESCRIPTION OF EMBODIMENTS OF THE PRESENT INVENTION

It is now appreciated that there can be utility in restricting separable objects disposed along the shaft of a writing instrument from rotating relative to one another.

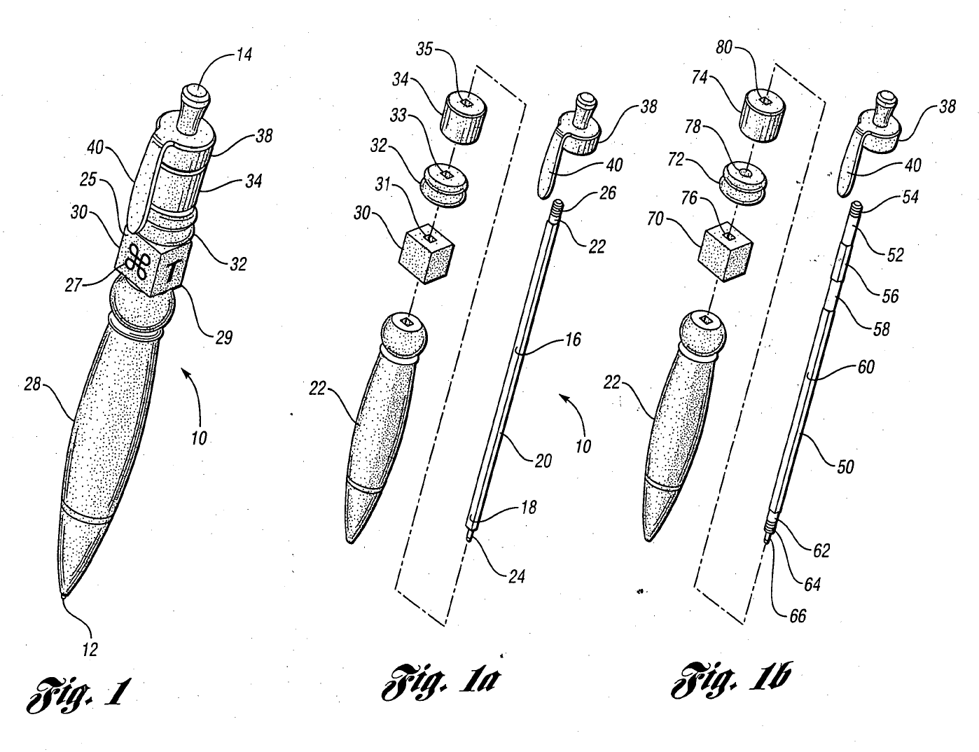

Referring to FIGS. 1 and 1a concurrently, writing instrument 10 generally includes head 12 and end 14 situated opposite head 12. Non-limiting examples of writing instruments include pens, pencils and felt-tip markers. Shaft 16 extends longitudinally from head 12 to end 14, and can be a ball point pen cartridge for storing a reservoir of ink. Shaft 16 includes a head portion 18, a middle portion 20 and an end portion 22. The end of head portion 18 supports rolling ball point 24 for delivering ink in the reservoir when rolled across paper or other suitable surface. The end portion 22 includes a series of screw threads 26 formed there-around.

The head portion 18 extends longitudinally through and is mated to a gripping portion 28, which is generally cylindrical, tapers towards the head 12, and is relatively wider than the shaft 16. The gripping portion 28 is suitable for gripping between the thumb and forefinger of the user to aid the user in the delivery of ink to a writable surface while utilizing the writing instrument 10. The gripping portion 28 is constructed of a plastic material, although other materials are suitable, for example, ceramic or metal. The inner surface portion of the gripping portion 28 near the head 12 of the writing instrument 10 can be complimentary to the cross-section of head portion 18 of the shaft 16 such that the end portion 18 becomes seated within the inner surface portion and the rolling ball point 24 extends outwardly from the distal end of the gripping portion 28 during and after mating of the gripping portion 28 with the shaft 16. In other embodiments, the inner surface portion includes female screw threads formed thereon for engaging complimentary male screw threads formed on head portion 18.

Writing instrument 10 includes objects 30, 32 and 34, which can be formed of any suitable material or materials, including plastic, metal, and wood. Channel 31 is formed through object 30 for receiving a portion of the shaft 16. Objects 32 and 34 likewise have channels 33 and 35, respectively, formed therein for receiving a portion of the shaft 16. The channels 31, 33 and 35 have a square cross-sectional shape which is complimentary to the square cross-sectional shape of the middle portion 20 of the shaft 16. Object 30 is formed in a dice shape or block shape, while object 32 is formed in the shape of a double-penny configuration and object 34 is formed in the shape of a cylinder.

As depicted in FIGS. 1 and 1a, the objects 30, 32 and 34 are dissimilar in shape to one another, although it should be appreciated that any two objects can be similar or dissimilar to one another. For example, a writing instrument can have all dice shaped blocks, or alternatively two (2) dice shaped blocks and one (1) single-penny or double-penny configured objects. It is also contemplated to have dice or other regular shaped objects mixed in with irregular shaped objects such as figurines of people, animals, houses, and so forth.

As shown in FIGS. 1, 1a and 1b, three (3) objects are disposed along a portion of the shaft 16, although a writing instrument can have any reasonable number of objects disposed along the shaft. For instance, the number of objects can be 2, 3, 4, 5, 6, 7, 8, 9, 11, or 12.

In addition to the objects having a channel to receive the shaft, the objects can be solid or hollow to any degree. As an example, a block can be hollow, and have a ball bearing movable disposed in the hollowed portion. One can also include any sort of electronics in one or more of the objects, for example, a battery or diode.

Any of the objects can have any sort of outside coating, coloring, pattern, words, logos, trademarks, etc. Foe example, outer surface 25 of object 30 includes image 27, while outer surface 29 includes the character “T”. In at least one embodiment, two or more of the objects can have lettering or an image that has a preferred sequence, as for example, blocks that spell a company name such as Microsoft™. As another example, the objects can be colored in order of wavelength, so that they can be arranged in a ROYGBIV order.

Objects 30, 32 and 34 are stacked on top of one another as shown in FIG. 1. After stacking, threaded end cap 38 is mated to the threads 26 of end portion 26, thereby retaining objects 30, 32 and 34 in a sequence between the gripping portion 28 and threaded end cap 38. In at least one embodiment, threaded end cap 38 includes an elongated clip arm 40 for attaching the writing instrument 10 to the writer's pocket or other suitable attachment structure. The user can unthread the threaded end cap 38 from the threads 26 so that the objects 30, 32 and 34 can be removed from the shaft 16. The user can then play with the removed objects independent of the writing instrument. Moreover, the user can replace one or more objects and then dispose the replaced set of objects on the shaft 16.

According to FIGS. 1 and 1a, the middle portion 20 of shaft 16 has a substantially square cross-section. It should be appreciated that shaft 16 can have a uniform cross-sectional shape through its entire length according to certain embodiments. In the embodiment shown in FIGS. 1 and 1a, each of the channels 31, 33 and 35 of objects 30, 32 and 34, respectively, have a complimentary cross-sectional shape. The middle portion 20 has a shaft cross-section that can used to restrict rotation of one or more objects by virtue of the shape of the shaft cross-section. The middle portion 20 has a substantially square cross-section, although other shapes that function to prevent rotation of one or more objects can be utilized, such as a triangular, half-circle, or star shaped cross-section. The restricted rotation feature can be beneficial in maintaining alignment of a word disposed on the outside of the objects. For example, nine (9) block-shaped objects can spell a company name such as Microsoft™ by each block having one of the letters on an outside surface when these surfaces are aligned. This alignment can be maintained with the restricted rotation feature.

Turning to FIG. 1b, an alternative shaft 50 according to another embodiment of the present invention is shown. Shaft 50 includes a circular end portion 52 with threads 54 formed thereon, a first middle square portion 56, a circular middle portion 58, a second middle square portion 60, and a circular head portion 62 with threads 64 formed thereon and ball point tip 66 extending therefrom.

Objects 70, 72 and 74 each have channels 76, 78 and 80, respectively, formed therethrough for receiving a portion of shaft 50. Channel 76 of object 70 has a square cross-section, which is received by shaft 50 and can be held by a portion of second middle square portion 60. Object 72 includes channel 78 having a circular cross-section, which is received by shaft 50 and can be held by a portion of circular middle portion 58. Object 74 includes a channel 80 having a square cross-section, which is received by shaft 50 and can be held by a portion of first middle square portion 56. According to this embodiment, objects 70 and 74 are not independently rotatable by virtue of the square cross-section of the first and second middle portions 56 and 58, while object 72 can be rotated about the shaft 50 due to its placement along the circular middle portion 58.

FIG. 1b depicts an example where some of the objects are independently rotatable and some not independently rotatable. As another example, one can have four (4) dice shaped blocks locked together to prevent independent rotation, one (1) intervening independently rotatable block, and then two (2) more blocks that are locked together. This embodiment can be readily manufactured by using a shaft with a triangular cross-section, the non-rotating blocks having a corresponding triangular shaped channel, and the rotating blocks having a round channel.

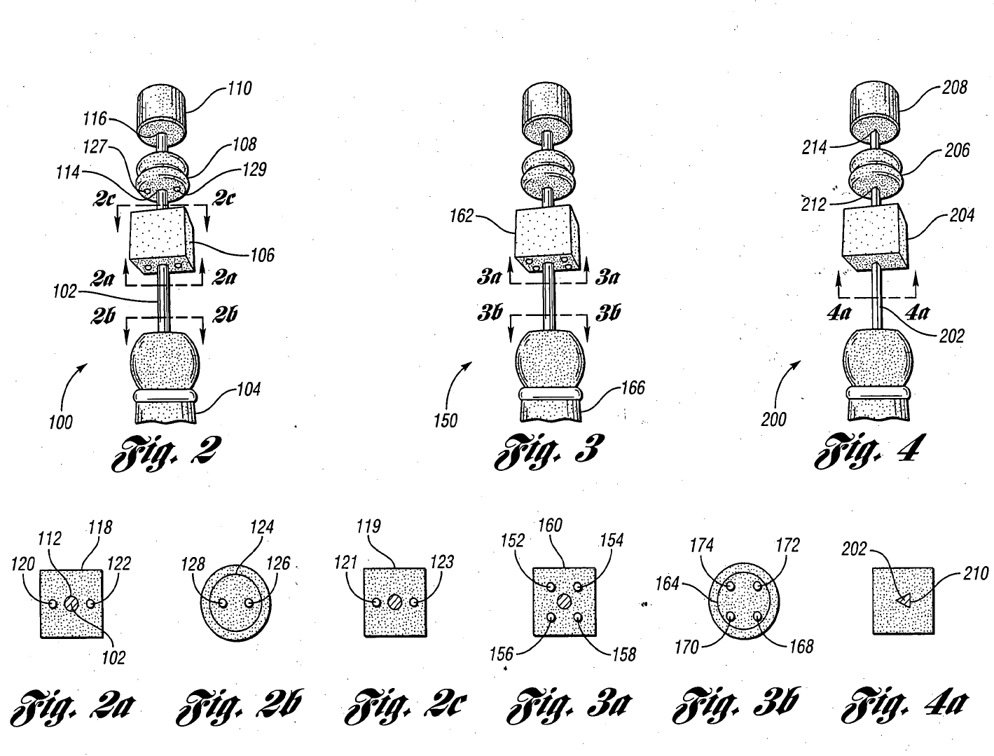

Turning to FIGS. 2, 2a and 2b, a fragment of a writing instrument 100 is shown according to an embodiment of the present invention. Shaft 102 is mated to gripping portion 104. Shaft 102 has a circular cross-section and objects 106, 108 and 110 have channels 112, 114 and 116, respectively, with complimentary circular cross-sections. As shown in FIG. 2, objects 106, 108 and 110 are in the midst of being disposed on shaft 102 in a final stacked configuration, which is exemplified by FIG. 1. Object 106 is formed in a dice shape or block shape, while object 108 is formed in the shape of a double-penny configuration and object 110 is formed in the shape of a cylinder.

The lower surface 118 of block-shaped object 106 includes first and second beads 120 and 122 formed thereon and spaced apart from each other and the intersection of shaft 102 and lower surface 118. The beads 120 and 122 can be formed of metal and glued to recessed portions of lower surface 118 for accommodating beads 120 and 122. The upper surface 124 of gripping portion 104 includes corresponding first and second recesses 126 and 128 formed therein and spaced apart from each other and the intersection of shaft 102 and upper surface 124. The first and second recesses 126 and 128 hold object 106 in relation to gripping portion 104 when the beads 120 and 122 are aligned with and at least partially within the recesses 126 and 128. It should be appreciated that one or more beads can be formed in the upper surface 124 of gripping portion 104 and one or more recesses can formed in the lower surface 118 of object 106. In at least one embodiment, one or more beads can be held at least partially within one or more recesses with an adhesive or magnetism.

In at least one embodiment, upper surface 119 of object 106 includes first and second recesses 121 and 123 formed therein, as depicted in FIG. 2c. Lower surface 125 of object 108 includes corresponding first and second beads 127 and 129 formed therein. The first and second recesses 121 and 123 hold object 108 in relation to object 106 when the beads 127 and 129 are aligned with and at least partially within the recesses 121 and 123.

It should be appreciated that the holding feature thus described can be utilized to hold two objects together such that independent rotation with respect to one another can be prevented. According to one or more embodiments of the present invention, the holding feature can include the use of a pin, detent, tongue, stop, pawl, catch, dog, cotter, hairpin, spike or the like.

Objects on a writing instrument can either be adapted so that any one object can juxtapose any other objects, or they can be adapted so that only some objects can mate appropriately with other objects. For example, several blocks may have three pins on one end, and three corresponding holes on the opposite end, but other blocks in a set may have only two pins on one end and two holes on the other. Still other blocks may have three pins and two holes on their opposite ends. In still another example, the top of a tree-shaped object may fit non-rotatably within the feet of a person-shaped object.

Turning now to FIGS. 3, 3a and 3b, writing instrument 150 is depicted with an alternative holding feature in which four beads 152, 154, 156 and 158 are formed on the lower surface 160 of block-shaped object 162. Each quadrant of lower surface 160 includes one of the four beads 152, 154, 156 and 158. The upper surface 164 of gripping portion 166 includes four corresponding recesses 168, 170, 172 and 174, which hold object 162 to gripping portion 166 when the beads 152, 154, 156 and 158 are aligned with and at least partially within the recesses 168, 170, 172 and 174.

Moving to FIGS. 4 and 4a, writing instrument 200 with an alternative shaft 202 is shown. Shaft 202 has a triangular cross-section and objects 204, 206 and 208 have channels 210, 212 and 214, respectively, with complimentary triangular cross-sections. The triangular cross-section restricts rotation of the objects 204, 206 and 208 by virtue of the shape of the shaft cross-section.

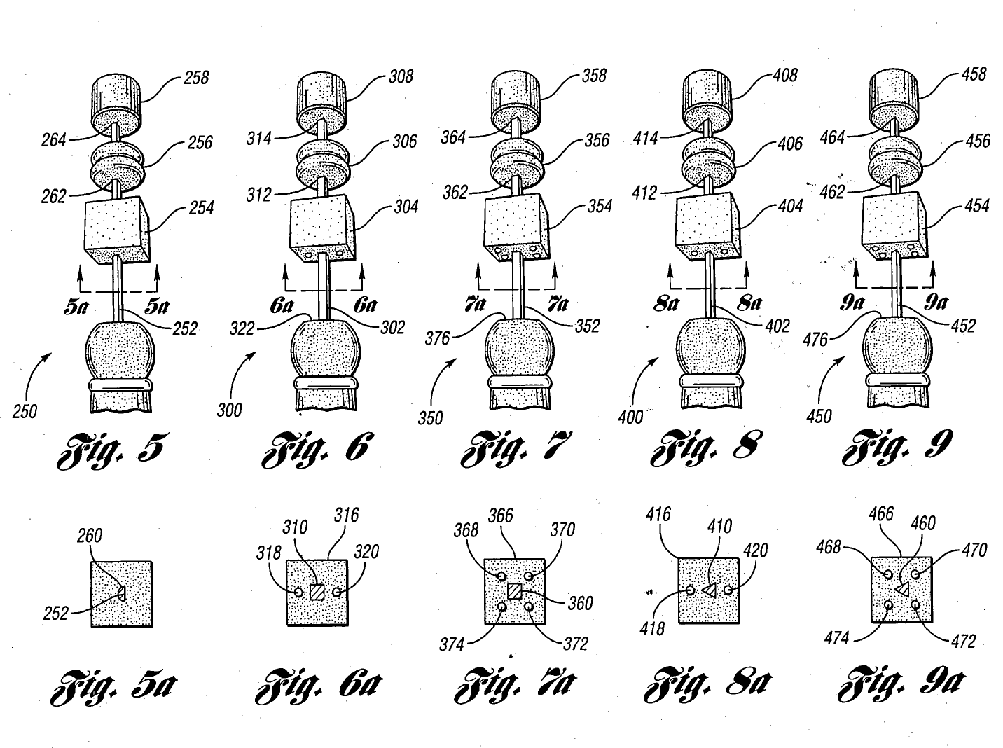

Turning to FIGS. 5 and 5a, writing instrument 250 with an alternative shaft 252 is shown. Shaft 252 has a half-circle cross-section and objects 254, 256 and 258 have channels 260, 262 and 264, respectively, with complimentary half-circle cross-sections. The half-circle cross-section restricts rotation of the objects 254, 256 and 258 by virtue of the shape of the shaft cross-section.

It should also be appreciated that the non-circular shaft cross-section feature can be combined with the holding feature in at least one embodiment of the present invention. For instance, FIGS. 6 and 6a depict writing instrument 300 with a shaft 302 having a square cross-section and objects 304, 306 and 308 having channels 310, 312 and 314, respectively, with complimentary square cross-sections. Lower surface 316 of object 304 includes first and second beads 318 and 320 and upper surface 322 includes first and second complimentary recesses (not shown). FIGS. 7 and 7a depict writing instrument 350 with a shaft 352 having a square cross-section and objects 354, 356 and 358 having channels 360, 362 and 364, respectively, with complimentary square cross-sections. Lower surface 366 of object 354 includes four beads 368, 370, 372 and 374 and upper surface 376 includes four complimentary recesses (not shown).

FIGS. 8 and 8a depict writing instrument 400 with a shaft 402 having a square cross-section and objects 404, 406 and 408 having channels 410, 412 and 414, respectively, with complimentary triangular cross-sections. Lower surface 416 of object 402 includes first and second beads 418 and 420 and upper surface 416 includes first and second complimentary recesses (not shown). FIGS. 9 and 9a depict writing instrument 450 with a shaft 452 having a triangular cross-section and objects 454, 456 and 458 having channels 460, 462 and 464, respectively, with complimentary triangular cross-sections. Lower surface 466 of object 454 includes four beads 468, 470, 472 and 474 and upper surface 476 includes four complimentary recesses (not shown).

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A writing instrument comprising:
a writing tip mechanically coupled to first and second holding parts;
separable first and second pieces positionable on the writing instrument, and at least partially retained in a sequence by the first and second holding parts; and
the first and second pieces having first and second anti-rotation configurations, respectively, that act to prevent their rotation with respect to one another.

2. The writing instrument of claim 1, where the first anti-rotation configuration comprises a detent.

3. The writing instrument of claim 1, where the first anti-rotation configuration comprises a plurality of detents.

4. The writing instrument of claim 1, wherein the first and second configurations are sized and dimensioned to cooperate with each other to prevent rotation of the first and second pieces with respect to one another.

5. The writing instrument of claim 4, wherein the first and second configurations are sized and dimensioned to prevent rotation relative to at least one of the holding parts.

6. The writing instrument of claim 4, wherein the first anti-rotation configuration comprises both a detent and an indentation.

7. The writing instrument of claim 6, wherein the detent and indentation are disposed on opposite ends of the first piece.

8. The writing instrument of claim 1, wherein the first anti-rotation configuration comprises a restrictive element other than a detent and an indentation.

9. The writing instrument of claim 8, further comprising a shaft having a non-circular cross-section, and wherein the first anti-rotation configuration comprises a channel having a cross-section that is non-rotatable with respect to the shaft.

10. The writing instrument of claim 9, wherein the non-circular cross-section comprises a polygon.

11. The writing instrument of claim 9, wherein the non-circular cross-section comprises a curvature of varying radius.

12. The writing instrument of claim 1, further comprising a shaft about which the pieces are disposed, the shaft having threads that mate with the first holding part.

13. The writing instrument of claim 1, the first piece is symmetrical about a long axis.

14. The writing instrument of claim 1, wherein the first piece includes text.

15. The writing instrument of claim 1, wherein the first piece includes an image.

16. The writing instrument of claim 1, wherein the first piece has a shape selected from the list consisting of a block, bead, and a ring.

17. The writing instrument of claim 1, wherein the first and second pieces have different lengths as measured along a long axis of the instrument.

18. The writing instrument of claim 1, wherein the first and second pieces have different lengths as measured along a long axis of the instrument.

19. The writing instrument of claim 1, further comprising a third piece positionable on the writing instrument and at least partially retained in a sequence by the first and second holding parts, and the third piece having a third anti-rotation configuration that acts to prevent rotation of the third piece with respect to at least one of the first and second pieces.

20. The writing instrument of claim 19, wherein at least two of the pieces have different shapes from one another.
